(19) United States
(12) Patent Application Publication
(10) Pub. No.: US 2005/0209842 A1
(43) Pub. Date: Sep. 22, 2005

(54) Remote USB port system and method

(75) Inventor: Steven A. Klein, Long Beach, CA (US)

Correspondence Address: SCHWEGMAN, LUNDBERG, WOESSNER & KLUTH, P.A., P.O. BOX 2938, MINNEAPOLIS, MN, 55402-0938, US

(73) Assignee: Digi International Inc.

(21) Appl. No.: 10/801,186

(22) Filed: Mar. 16, 2004

(51) Int. Cl. G06F 13/12

(52) U.S. Cl. 703/25; 710/62

(57) ABSTRACT

A remote computerized server has one or more Universal Serial Bus (USB) ports, and a host computer has a driver communicatively coupling the host computer to the remote computerized server. The host computer driver emulates the USB ports of the remote computerized server by emulating a corresponding local USB port for each of the USB ports of the remote computerized server, and exchanges data with the remote computerized system driver to emulate one or more of the remote computerized system's USB ports as USB ports local to the host computer.

### FIELD OF THE INVENTION

The invention relates generally to computerized communication, and more specifically to a system and method for providing virtual remote USB ports.

### BACKGROUND OF THE INVENTION

Although the first computers were used as standalone devices that processed the information brought to them and provided results to be taken away and utilized, modern computer networks have made the computer's role not only one of processing information but also one of communicating information.

Terminals such as serial TTY (teletype) devices were used as relatively unsophisticated devices to provide access to a computer, such that a user could use a terminal with little or no processing capability of its own to interact with a computer. Multiple TTY ports per computer enabled larger computers to provide processing capability for many users simultaneously, as well as connection of various other devices such as modems to exchange data between computers. These TTY ports evolved into the serial port that is still found on most personal computers, and is occasionally used for purposes such as connecting an external modem or other low-speed peripheral device.

Local area network (LAN) adapters, modems, and Internet connections have become commonplace components of computers today, and enable computers to exchange information with each other in standardized and reliable ways. Access to control of remote computers, transfer of files, e-mail, and streaming multimedia are all common in modern networks, and are all relied upon in both personal communication and in conducting modern business.

Various local peripheral devices are attached to computer systems via a variety of recently developed technologies, such as USB, FireWire, Bluetooth, and other protocols and interfaces. Perhaps the most common of these is the Universal Serial Bus (USB) port, which provides connectivity to one or more USB devices at significantly higher speed than traditional serial ports. Further, USB is designed as a plug-and-play interface, such that attaching a new peripheral device results in searching for and loading an appropriate device driver for the new peripheral if such a driver is available.

It may be desired in some situations, such as where the environment for USB peripheral devices is hostile, is remote, or where the USB devices are physically dispersed, to be able to control the USB devices from a local computer. While networking provides the capability for two computers to communicate with each other, and USB provides the capability for a computer to communicate with a USB device, no method or system presently allows remote communication with a USB device.

It is therefore desired for a local computer to be able to address a remote USB device as if it were a locally attached USB device.

### SUMMARY OF THE INVENTION

The present invention in one example embodiment comprises a remote computerized server having one or more Universal Serial Bus (USB) ports, and a host computer having a driver communicatively coupling the host computer to the remote computerized server. The host computer driver emulates the USB ports of the remote computerized server by emulating a corresponding local USB port for each of the USB ports of the remote computerized server, and exchanges data with the remote computerized system driver to emulate one or more of the remote computerized system's USB ports as USB ports local to the host computer.

### BRIEF DESCRIPTION OF THE FIGURES

FIG. 1 shows a networked manufacturing configuration with remote USB ports, consistent with an embodiment of the present invention.

FIG. 2 is a flowchart illustrating a method of providing one or more remote USB ports to a host computer, consistent with an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

A user of a local computer may wish to control a hardware port on a remote computer, such as where a user of a local computer wishes to control one or more USB ports on one or more remote computers to effectively provide control of a large number of USB ports or of remotely located USB ports from a local computer. Such a system would allow a single local computer to control via one or more remote computers a large number of USB ports, each of which may have one or more devices such as a digital camera, PDA, scanner, or other peripheral device attached. For example, a host computer may be linked via a network such as the Internet to one or more remote server computerized systems, each of which has one or more USB ports, each USB port having a peripheral device attached thereto, such that the host computer effectively controls each of the peripheral devices via a virtual USB port implemented in a driver providing communication between the host and remote server computers.

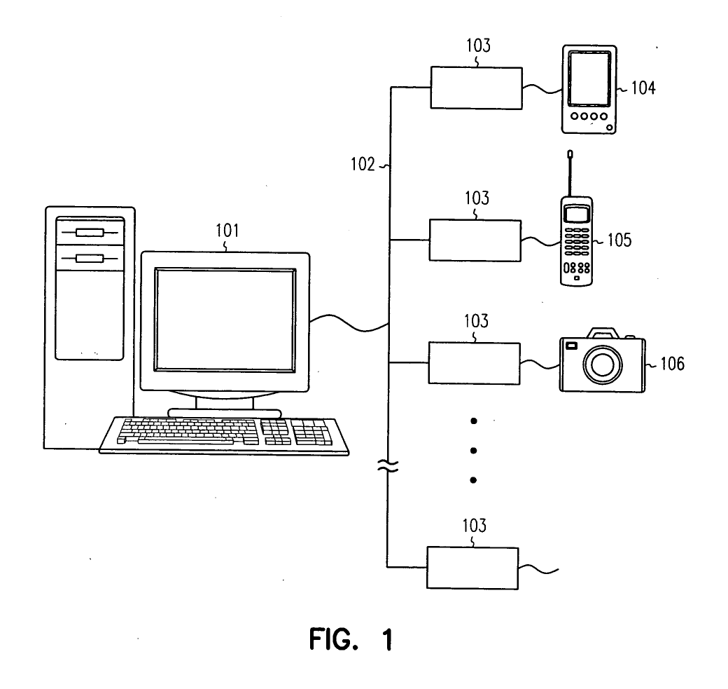

Such as system would facilitate efficient and centralized control of USB devices in an environment where the remote computer and USB peripheral device environments are hostile, remote, or physically dispersed, such as in a product manufacturing environment. One example of such a system is illustrated in FIG. 1.

FIG. 1 shows a host computer coupled to remote servers having virtual USB ports, consistent with an embodiment of the present invention. The host computer 101 is connected via a network connection 102 such as the Internet or a TCP/IP connection, to at least one remote computerized server 103. The remote servers 103 have one or more Universal Serial Port (USB) ports on them, such that USB peripheral devices can be attached. For example, FIG. 1 shows a Personal Digital Assistant (PDA) 104, a cellular telephone or cell phone 105, and a digital camera 106. These devices are representative of various devices that can be connected to computers via a USB port, and is not limited to use of the specific devices shown in this example.

In operation, the host computer 101 communicates via the network connection 102 with the remote computerized servers 103. The remote computerized systems in various embodiments take the form of a standard personal computer, a computer configured to operate unattended and without user intervention, or any other configuration operable to perform the various functions and having the various components required to practice an embodiment of the present invention.

The host computer executes a software USB driver, operable to receive USB port instructions and data, to encode the instructions and data, and to send that data to the remote computerized servers 103. The remote computerized servers then receive the instructions and data, and a software driver operating on the remote computerized servers converts the instructions and data back to USB instructions and data, and conveys the data over one or more attached USB ports. The remote computerized server drivers are similarly operable to receive data from the USB peripheral devices such as PDA 104, cell phone 105, and digital camera 106, and to convey the received data and instructions via network connection 102 back to the nost computer 101. The host computer 101's driver then can convert the received data and instructions to USB format data and instructions, and forward the data and instructions to the application executing on the host computer.

The host computer's driver is configured so that the USB ports on the remote computerized servers 103 appear to software programs executing on the host computer 101 to be USB ports local to the host computer. In one such embodiment, an Application Programming Interface (API) provides an interface between the program application executing on the host computer 101 and the driver that conveys the USB instructions over the network 102. The application programs call the various functions of the API to control the USB ports of the remote computer servers 103 as if the USB ports were local to the host computer. The drivers on the host computer 101 and on the one or more remote computerized servers 103 are thereby configured to enable communication of the USB instructions over network connection 102, so that the remote computerized systems and the host computer may be physically remote from one another, or may be geographically dispersed.

For example, consider the configuration shown in FIG. 1 in the context of a manufacturing facility. Host computer 101 operates from a clean control room, and executes a program that installs software and configures PDAs 104 as a final manufacturing step. The various remote computerized servers 103 are distributed throughout the manufacturing floor in different production lines, and are both dispersed throughout the manufacturing floor and located in a relatively hostile manufacturing environment. Due to the hostile environment of the manufacturing facility, remote computer servers 103 are specially configured to operate in a hostile environment, and without requiring user intervention to operate.

In a further embodiment, the various remote computer servers 103 are located at different remote locations, and the network connecting them to host computer 101 is a public network such as the Internet. Because the data traveling between host computer 101 and the remote computerized servers 103 may be intercepted by other users of the computerized network, the data is in some embodiments encrypted or secured using various encryption technologies. Encryption of the data takes different forms in varying embodiments of the invention, including but not limited to various symmetric algorithms, public key algorithms, and one-way hash functions. Various embodiments of the invention rely on algorithms such as these being implemented in software on the host computer 101 and on each of the one or more remote server computers 103, such as within a software driver executing on the respective computers. Any of the encryption methods described here and any other suitable encryption method may be used in various embodiments of the invention to secure data transmitted between the host computer and the remote computerized servers of the present invention, ensuring that the data transmitted between the host and remote servers is authentic and secure.

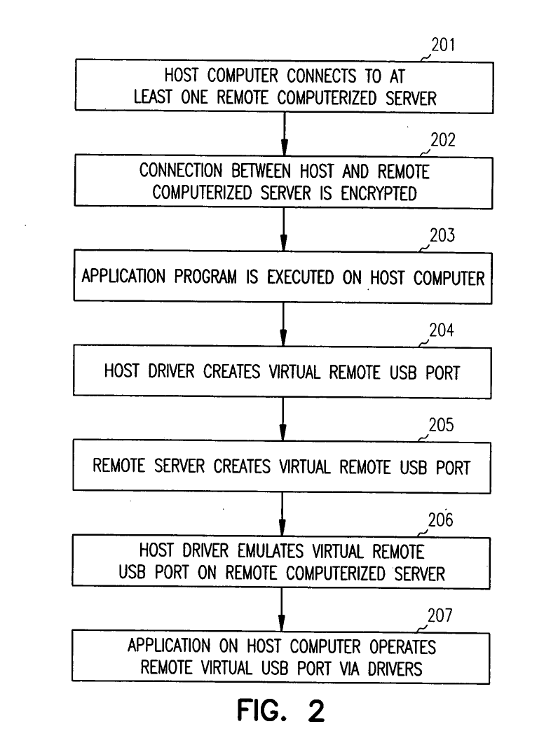

Operation of such a system is shown in greater detail in the flowchart of FIG. 2. At 201, the host computer initiates a network connection to one or more remote computerized servers. In a further embodiment, the connection is established by a driver executing on the host computer, and is a TCP/IP connection. At 202, encryption of the connection is established. At 203, an application program, driver, or other software desiring access to the remote server's virtual USB ports executes on the host. In other embodiments, the connection will be established through other methods, such as by remote server initiation.

At 204, the driver executing on the host computer maintains the connection between the host and server as the application program requests one or more virtual remote USB ports and creates one or more corresponding local virtual USB ports. At 205, a corresponding remote virtual USB port is established on a remote computerized server. The host driver then emulates the one or more configured remote virtual USB ports local to the remote server via the host's created virtual remote USB port at 206. In some embodiments, the remote server notifies the host computer application or driver when a device is plugged into the remote USB port, creating a virtualized USB device accessible via the drivers executing on the host computer and remote server as though the device were local to the host computer. At 207, the application program executing on the host controls the remote server's attached USB devices via the remote virtual USB ports provided by an API and the host's USB port emulation driver.

In a further embodiment of the invention, each virtual USB port on the host computer does not map directly to a single virtual USB port on the remote servers, but have multiple host computers each seeing the same USB port or device as a virtual USB port or device. Similarly, in some environments such as manufacturing, embodiments of the invention will include a single virtual USB port or device on the host mapping to multiple physical USB ports or devices attached to remote servers, such that a single host operation will operate on more than one remote port or device. In such situations, it will also be valuable to attach multiple devices per USB port, so that a single remote virtual USB port can provide connectivity for several (up to 128 using current technology) virtual USB devices to the host computer.

The methods and systems described herein illustrate how the present invention can provide virtual remote USB port access to an application program executing on a host computer. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A system comprising:
a remote computerized server having a one or more Universal Serial Bus (USB) ports; and
a host computer having a driver communicatively coupling the host computer to the remote computerized server, wherein the driver emulates the USB ports of the remote computerized server by emulating a corresponding local USB port for each of the USB ports of the remote computerized server, and exchanges data with the remote computerized system driver to emulate one or more of the remote computerized system's USB ports as USB ports local to the host computer.

2. The system of claim 1, wherein the host computer and remote computerized server are connected via a TCP/IP connection.

3. The system of claim 1, wherein the host computer and remote computerized server are connected via a secure connection.

4. The system of claim 1, wherein the host computer driver further comprises an application programming interface (API), by which an application program executing on the host computer is granted control of at least one USB port of a remote computerized server, as if the USB ports of the remote computerized server were local to the host computer.

5. The system of claim 1, wherein the remote computerized server has a driver executing thereon, operable to communicate data between at least one of its one or more USB ports and the host computer via the network.

6. A system comprising:
a host computer having a driver communicatively coupling the host computer to a remote computerized server, wherein the driver emulates at least one USB port of the remote computerized server by emulating a corresponding local USB port for each of the USB ports of the remote computerized server.

7. A system comprising:
a remote computerized server having a one or more Universal Serial Bus (USB) ports and a driver executing thereon, the driver operable to communicate data between at least one of its one or more USB ports and a host computer via a network, wherein the host computer has a driver communicatively coupling the host computer to the remote computerized server, and wherein the driver emulates the USB ports of the server by emulating a corresponding local USB port for each of the USB ports of the remote computerized server.

8. A method of providing at least one remote virtual Universal Serial Bus (USB) port to a host computer, comprising:
loading a driver on a remote computerized system having at least one USB port and connected to the host computer via a network, such that the host computer and driver are operable to communicate data between at least one of its one or more USB ports and the host computer via the network; and
loading a driver on the host computer, the driver and host computer operable to communicatively couple the host computer to the remote computerized server, wherein the driver emulates the USB ports of the remote computerized system by emulating a corresponding local USB port for each of the USB ports of the remote computerized server, and exchanges data with the remote computerized system driver to emulate one or more of the remote computerized system's USB ports as USB ports local to the host computer.

9. The method of claim 8, wherein the host computer and remote computerized system are connected via a TCP/IP connection.

10. The method of claim 8, wherein the host computer and remote computerized system are connected via a secure connection.

11. The method of claim 8, wherein the host computer driver further comprises an application programming interface (API), by which an application program executing on the host computer is granted control of at least one USB port of a remote computerized server, as if the USB ports of the remote computerized server were local to the host computer.

12. A method of providing at least one remote virtual Universal Serial Bus (USB) port to a host computer, comprising:
loading a driver on a remote computerized system having at least one USB port and connected to the host computer via a network,
such that the host computer and driver are operable to communicate data between at least one of its one or more USB ports and the host computer via the network,
such that the host computer is able to emulate the USB ports of the remote computerized system by emulating a corresponding local USB port for each of the USB ports of the remote computerized server, and
such that the remote computerized system is operable to exchange data with the host system to emulate one or more of the remote computerized system's USB ports as USB ports local to the host computer.

13. A method of providing at least one remote virtual Universal Serial Bus (USB) port to a host computer, comprising:
loading a driver on the host computer, the driver and host computer operable to communicate data via a network with at least one remote computerized server having at least one USB port,
wherein the driver on the host computer emulates at least one USB port of the remote computerized system by emulating a corresponding local USB port for each of the USB ports of the remote computerized server, and
wherein the driver on the host computer is operable to exchange data with a remote computerized system driver to emulate one or more of the remote computerized system's USB ports as USB ports local to the host computer.

14. A machine-readable medium with instructions stored thereon, the instructions when executed operable to cause emulation of at least one remote computerized system Universal Serial Bus (USB) port on a host computer, by:
loading a driver on a remote computerized system having at least one USB port and connected to the host computer via a network, such that the host computer and driver are operable to communicate data between at least one of its one or more USB ports and the host computer via the network; and
loading a driver on the host computer, the driver and host computer operable to communicatively couple the host computer to the remote computerized server, wherein the driver emulates the USB ports of the remote computerized system by emulating a corresponding local USB port for each of the USB ports of the remote computerized server, and exchanges data with the remote computerized system driver to emulate one or more of the remote computerized system's USB ports as USB ports local to the host computer.

15. The machine-readable medium of claim 14, wherein the host computer and remote computerized system are connected via a TCP/IP connection.

16. The machine-readable medium of claim 14, wherein the host computer and remote computerized system are connected via a secure connection.

17. The machine-readable medium of claim 14, wherein the host computer driver further comprises an application programming interface (API), by which an application program executing on the host computer is granted control of at least one USB port of a remote computerized server, as if the USB ports of the remote computerized server were local to the host computer.

18. A machine-readable medium with instructions stored thereon, the instructions when executed operable to cause emulation of at least one remote computerized system Universal Serial Bus (USB) port on a host computer, by:
loading a driver on a remote computerized system having at least one USB port and connected to the host computer via a network,
such that the host computer and driver are operable to communicate data between at least one of its one or more USB ports and the host computer via the network,
such that the host computer is able to emulate the USB ports of the remote computerized system by emulating a corresponding local USB port for each of the USB ports of the remote computerized server, and
such that the remote computerized system is operable to exchange data with the host system to emulate one or more of the remote computerized system's USB ports as USB ports local to the host computer.

19. A machine-readable medium with instructions stored thereon, the instructions when executed operable to cause emulation of at least one remote computerized system Universal Serial Bus (USB) port on a host computer, by:
loading a driver on the host computer, the driver and host computer operable to communicate data via a network with at least one remote computerized server having at least one USB port,
wherein the driver on the host computer emulates at least one USB port of the remote computerized system by emulating a corresponding local USB port for each of the USB ports of the remote computerized server, and
wherein the driver on the host computer is operable to exchage data with a remote computerized system driver to emulate one or more of the remote computerized system's USB ports as USB ports local to the host computer.

20. A hardware device for a host computer system, the hardware device having a driver communicatively coupling the host computer to a remote computerized server, wherein the driver emulates at least one Universal Serial Bus (USB) port of the remote computerized server by emulating a corresponding local USB port for each of the USB ports of the remote computerized server.

21. A hardware device having a one or more Universal Serial Bus (USB) ports and a driver executing thereon, the driver operable to communicate data between at least one of the one or more USB ports and a host computer via a network, wherein the host computer has a driver communicatively coupling the host computer to the hardware device, and wherein the driver emulates the USB ports of the hardware device by emulating a corresponding local USB port for each of the USB ports of the hardware device.
